(19) United States
(12) Patent Application Publication
(10) Pub. No.: US 2006/0253335 A1
(43) Pub. Date: Nov. 9, 2006

(54) Cash based purchasing using mobile communication

(76) Inventors: Gerard Keena, Mullingar (IE); Derek Grogan, Bray (IE)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/542,677

(22) PCT Filed: Jan. 22, 2004
(86) PCT No.: PCT/IE04/00007

§ 371 Date: May 10, 2006

Related U.S. Application Data
(60) Provisional application No. 60/441,826, filed on Jan. 22, 2003.
(60) Provisional application No. 60/447,119, filed on Feb. 13, 2003.

(51) Int. Cl. G06Q 30/00

(52) U.S. Cl. 705/26

(57) ABSTRACT

A system and method for cash based purchasing using electronic commerce channels such as mobile telephone networks. Customers use cash to purchase goods and services by using a vendor's point of sale device such as a mobile telephone. A server side mobile wallet provides secure storage of user identity and profiles and a payment mechanism for users to obtain goods and services from a point of sale device. Service providers or suppliers pay a commission to point of sale vendors for use of the vendor's account and point of sale device to perform transactions for customers. A platform is provided for establishment and use of hierarchal vendor network over a number of different mobile channels.

### CROSS REFERENCE TO RELATED APPLICATIONS

The present invention claims priority to U.S. Provisional Patent Application No. 60/411,826 filed Jan. 22, 2003 and U.S. Provisional Patent Application No. 60/447,119 filed Feb. 13, 2003 which are both hereby incorporated herein by reference in their entirety.

### FIELD OF THE INVENTION

The present invention relates to a system and method for conducting electronic commerce and more particularly to a system and method for cash based purchasing of services provided electronically using a vendor's mobile communication device at the point of sale.

### BACKGROUND OF THE INVENTION

Consumers of electronically provided goods and services can presently choose from a number of payment methods to make electronic payments to the goods supplier or service provider. Such payment methods typically involve the use of credit cards, debit cards, digital cash, electronic funds transfer or the like.

In order for a service provider or supplier of non-tangible or remotely accessed goods such as digital media, content, access to utilities to sell the goods or services on-line or over mobile communications networks, the supplier must ordinarily make use of an existing on-line or mobile retail channel in which customers are able to purchase the goods or services on-line. Customers using mobile payment services must therefore have access to a traditional payment instrument such as a credit or debit card. Accordingly, this type of electronic commerce requires an infrastructure including at least fixed line networks and Internet availability.

A supplier who intends to sell services/products over a mobile telephone network or Internet typically enters a contractual agreement with an on-line retailer or distributor. Payment terms and credit worthiness of the supplier and distributor are established and confirmed as part of the contractual arrangement. A customer who wishes to perform a traditional transaction using electronic channels of commerce such as purchasing products or services over the Internet or a mobile telephone, must typically possess a payment instrument (i.e. a credit card or debit card) suitable for presentation and verification in the traditional channel.

The customer must typically register name, address, telephone number and payment instrument identifiers (i.e. credit card number, bank account number etc.). In some transactions in which a customer is pre-registered with a distributor, the customer can make a payment by simply activating a pre-registered payment instrument. For example, if the payment instrument is a bank account, a mobile commerce application can, upon activation, access the customer's bank account and transfer the value of the service/product from the customer's bank account to the retailer/distributor's account. The retailer/distributor can then finish processing the customer's order and deliver the ordered goods or services to the customer.

Such traditional electronic channels of commerce can be expensive and therefore impractical for use by many small business and start-up businesses, for example. The expensive infrastructural requirements can present an insurmountable barrier to market entry for many e-commerce service and/or distribution businesses.

A particular drawback of traditional electronic channels of commerce is the necessity to perform credit checks on the various components in the channel. In an extended chain of commerce, credit checks alone can present a prohibitive barrier to entry for a retailer. Another particular drawback of traditional electronic channels of commerce is necessity for the channel to build up inventory. In an extended chain of commerce, substantial inventory must be produced and supplied to the chain before sales can be made to a final customer. Still another drawback of traditional on-line channels of commerce is the inflexibility of a typical channel. For example, typical on-line channels of commerce are not easily scalable and are therefore unsuitable for developing expanded vendor networks.

Many improvements are being developed to the traditional model of electronic channels of commerce. For example, U.S. Pat. No. 6,456,984 to Demoff et al. (hereinafter “Demoff”) discloses a method and system for issuing credit as payment in consumer transactions which eliminates the need for traditional credit cards and minimizes fraud and theft. Concurrent with a particular transaction, a request is made for issuance of a credit transaction number. The credit transaction number is randomly generated and made valid only for the instant transaction. The credit transaction numbers are continually recycled for subsequent requests irrespective of the customer identity. The request can be made from a mobile communication device or personal computer using an electronic commerce program. Transactions between customers and registered or known vendors can be automatically carried out by a centralized service provider without generating the unique, temporary number, or without the need for the customer or vendor to exchange personal information.

Improved methods of point of sale distribution of pre-paid debit cards have been disclosed in U.S. Pat. No. 6,405,182 to Curevo and U.S. Pat. No. 6,169,975 to White et al., for example. Each of the improved methods heretofore known retains the infrastructural requirements that are a cost barrier to vendors and a burden to potential customers.

One known method of cash based access to electronic commerce involves the use of scratch cards wherein usage codes for services are provided on scratch cards which are sold for cash. This method is used in certain emerging markets where mobile telephone usage is increasing. However, the cost of scratch card production, distribution and security can be prohibitive particularly as the value of the top-up itself may be relatively small in relation to these fixed costs. Alternative strategies that are becoming popular in developed economies, including point of sale (POS) and asynchronous transfer mode (ATM) top-up methods, are often not practical due to absence of infrastructure or low numbers of banked subscribers.

### SUMMARY OF THE INVENTION

The present invention provides a system and method for cash based purchasing using electronic commerce channels such as mobile telephone networks. The invention provides customers with a convenient way of using cash to purchase goods and services by using a vendor's point of sale device such as a mobile telephone. The invention incorporates a server side mobile wallet which provides secure storage of user identity and profiles and a payment mechanism for users to obtain goods and services from a point of sale device. Service providers or suppliers pay a commission to point of sale vendors for use of the vendor's account and point of sale device to perform transactions for customers. The invention provides a platform for easily establishing and deploying a hierarchal vendor network over a number of different mobile channels.

The illustrative embodiment provides a method for cash payment of goods ordered on-line. In the illustrative method, a distributor's debit or credit account is established in a supplier's mobile commerce system. Payment is made from a customer to the distributor. A request for the goods or services is communicated from the distributor to a supplier using a mobile device connecting to a mobile commerce system of the supplier. Authentication of the distributor and verification of the distributor's funds is performed by the mobile commerce system. The value of goods or services is transferred from the distributor's account to the supplier's account in the supplier's mobile commerce system. An order acknowledgement is communicated from the suppler to the distributor. Access to the goods or services is transferred from the distributor to the customer. The distributor can optionally inform the customer when a transaction has been completed.

An illustrative embodiment of the present invention provides a method for cash payment for goods or services in a mobile commerce system. A distributor's account is established in a mobile commerce system which also includes a supplier's account. Value is paid for the goods or services from the customer to the distributor. A request is communicated for the goods or services from the distributor to a supplier using a communication device in the mobile commerce system. The distributor is authenticated and the distributor's funds are verified by the mobile commerce system. An order acknowledgement is communicated from the supplier to the distributor. Value is transferred for the goods or services from the distributor's account to the supplier's account and access to the goods or services is transferred to the customer. A transaction completed message is communicated from the distributor to the customer.

In an illustrative embodiment of the invention, the access to goods or services includes a token provided to the customer which can be provided from the customer to the supplier to allow the customer's direct access to the services. In another embodiment, the access includes a code provided to the customer which can be provided from the customer to the supplier to allow the customer's direct access to the services. In still another embodiment the access includes direct activation of the services by the supplier.

In at least one embodiment of the present invention, the communication device is a mobile communication device such as a mobile telephone. The goods or services can comprise airtime in a mobile telephone network, for example, wherein the mobile commerce system is integrated with the mobile telephone network or a component thereof. In another embodiment, the goods or services can be a utility service such as the delivery of electricity.

According to the illustrative embodiment, value can optionally be transferred from the distributor's account to the supplier's account via a network of sub-distributors. The network of sub-distributors can be configured as a hierarchical network, for example. In the illustrative embodiment of the invention commission value is provided to the distributor. The commission value can include a bulk discount for distributed services in relation to an amount deposited in the distributor's account. Alternatively, the commission value can be a payment calculated in relation to the value of sales made by the distributor.

Another illustrative embodiment of the present invention provides a mobile commerce network including, a mobile communication network, a supplier having mobile communication capability over the mobile communication network and at least one distributor having mobile communication capability over the mobile communication network. The network includes a supplier's account addressable over the mobile communication network and a distributor's account addressable over the mobile communication network. The supplier authenticates the distributor, verifies funds in the distributor's account, and transfers value to a customer in response to request received from the distributor over the mobile communication network. The network in the illustrative embodiment can optionally includes a hierarchical network of distributors.

Still another embodiment of the present invention provides a cash based purchasing platform for creation of a mobile commerce network including a mobile payments platform having a mobile stored value module; and a service delivery platform configured for integration with the mobile payments platform.

In this embodiment the mobile payments platform facilitates communication of electronic payment instructions between a distributor and supplier over the mobile commerce network. The service delivery platform facilitates activation of services for a customer over the mobile commerce network. The mobile stored value module facilitates establishment of a low cost network of distributors having deposit accounts for transfer of funds to a supplier in exchange for activation of services for a customer when a customer makes cash payments to a distributor. The mobile payments platform and service delivery platform are capable of use with a plurality of different communication channel protocols.

The various embodiments of the present invention solve the problems of prior art systems and methods for electronic commerce by providing a system and method for conducting electronic commerce including payment for and delivery of services and/or goods using electronic channels of commerce which does not require an expensive infrastructure or a large cost for vendors to enter the market. The present invention also features a system and method for electronic commerce which may not require confirmation of a potential customer's creditworthiness. The system and method of Internet commerce according to the present invention is provided for use by vendors over mobile communications networks and is scalable for use in extended vendor networks.

The invention also features a system and method which can be implemented over a number of different mobile channels and thereby adapted to different geographies without changing the core platform. The system and method according to the present invention is supported by distributors of goods and services by payment of commission to mobile vendors.

The present invention is particularly useful in emerging markets where mobile phone penetration is growing but where few alternatives exist for providing prepaid top-ups. Alternative strategies that are becoming popular in developed economies, such as POS and ATM top-up solutions, are often not practical due to absence of infrastructure or low numbers of banked subscribers.

The mobile telephone top-up embodiment of the present invention creates a mobile point-of-sale network based around the very technology that requires the top-up service thereby overcoming the disadvantages of alternative top-up methods such as POS and ATM which require an established infrastructure.

These and other features of the present invention will be better understood with reference to the following drawings.

### BRIEF DESCRIPTION OF THE DRAWINGS

FIG. 1 shows a system architecture in accordance with the present invention.

FIGS. 2A to 2E show a cash top-up method in accordance with the present invention.

FIG. 3 is an illustrative method of crediting a vendor's stored value module.

FIG. 4 is an exemplary method of how vendor stored value modules may be credited and system stored value module debited in accordance with the present invention.

FIG. 5 shows an embodiment of the present invention implemented using a hierarchical stored value module structure.

FIG. 6 is an example, using the structure of FIG. 5 of how the system may log all transfers and transactions by vendors.

FIG. 7 is an example of a cash top-up transaction and payment processing method in accordance with the present invention.

FIG. 8 is an exemplary schematic flow sequence showing the effecting of a relationship between a supplier and distributor in accordance with the present invention.

FIG. 9 is an exemplary schematic flow sequence showing the interaction between a customer, distributor and supplier in accordance with a method of the present invention.

### DETAIL DESCRIPTION OF THE INVENTION

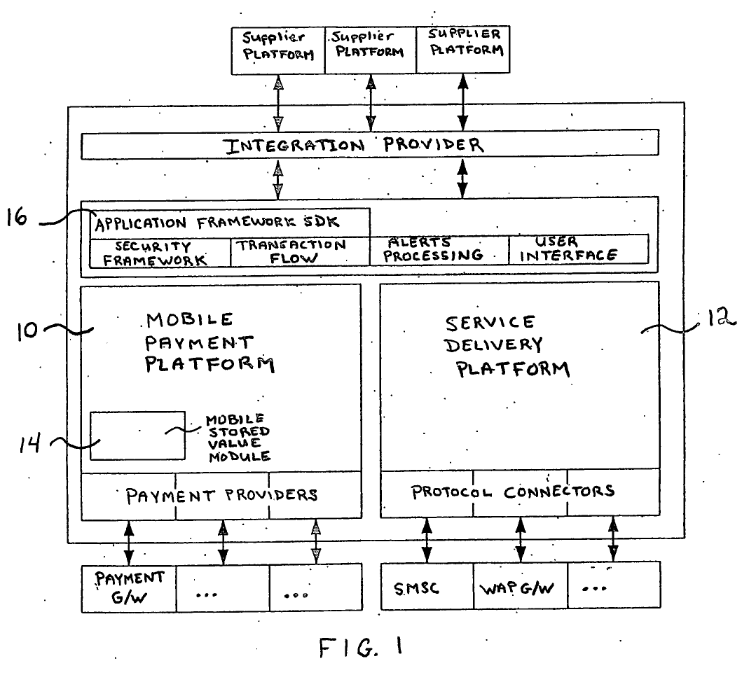

An illustrative embodiment of the present invention is described with reference to FIG. 1. The illustrative embodiment includes a mobile payments platform 10 which provides registration, security and authentication functionality, payment processing, transaction processing and secure storage. Another primary component of the present invention is a service delivery platform 12 which provides reliable delivery of short messaging service (SMS) messages, as well as enabling service delivery over other channels and protocols such as web protocol, Unstructured Supplementary Service Data (USSD) and MMS (Multimedia Messaging Systems). A cash based purchasing platform according to the present invention also includes a cash based software developer's kit (SDK) 16 and multiple cash based purchasing SMS applications.

The mobile payment platform 10 according to an illustrative embodiment of the present invention is a carrier-grade mobile “wallet” platform that allows service providers such as mobile operators, financial originations and enterprises to provide advanced m-commerce services to their customers. The “wallet” incorporates payment or top-up, i.e. (value store) functionality in a mobile format having functionality as described hereinafter. The disclosed mobile payment platform supports multiple, value-added applications and services that customers can access using their personal mobile wallet. Customers can pay easily and securely for goods and services using a range of payment options including pre and post-pay billing, stored value accounts, loyalty points and traditional debit or credit cards. Further, customers can personalize the contents, access and presentation of their wallets.

The disclosed mobile payment platform 10 allows controlled, reliable access to payment processing, settlement, merchant integration, security and fulfilment systems. The mobile payment platform 10 according to the invention supports a range of transactions from micro-payments up to very large value purchases. Support is provided for any usage level from occasional purchases through regular payments and for prepaid top-up payments. The mobile payment platform 10 according to the present invention provides security and high-availability, and is capable of supporting hundreds of applications and millions of users. The mobile payment platform 10 can thereby be used for rapid development and deployment of new applications and services.

In a particular embodiment of the present invention, a mobile stored value module 14 provides an extension of the mobile payment platform (mobile wallet). The mobile stored value module 14 provides a stored value account or stored value module system which can be used to make micro-payments or prepayment of funds for services. Using the mobile stored value module 14, registered users (registered wallet holders) may prepay funds which can later be used to make payments for certain goods and services. The stored value module system offers an alternative payment option useful in situations where subscribers are not banked or where transaction values are too small to justify the high fixed costs or meet minimum limits associated with traditional payment instruments.

The service delivery platform 12 according to an illustrative embodiment of the present invention is a carrier-grade messaging platform that hosts mobile applications and provides the mobile applications with efficient access to a variety of messaging and content delivery channels. The service delivery platform 12 connects any number of hosted applications with a variety of transport channels such as Short Messaging Services (SMS), Multimedia Messaging System (MMS), email and Wireless Application Protocol (WAP) Push.

A key advantage of the service delivery platform 12 according to the illustrative embodiment of the present invention is its ability to communicate on multiple messing systems simultaneously. For example, a single application using the service delivery platform 12 according to the invention can receive a request over an SMS channel and reply over a MMS or email channel. Accordingly, the present invention facilitates the development of electronic commerce applications that are broad in reach and rich in content.

The service delivery platform 12 according to the invention is portable between operating systems and is capable of supporting multiple concurrent applications. The service delivery platform 12 according to the illustrative embodiment of the present invention is designed to run in a clustered, redundant configuration, provides high availability and is scalable to support hundreds of applications and millions of subscribers.

The SDK 16 according to an illustrative embodiment of the present invention encapsulates the functional elements necessary for performing a cash purchase independent of any user interface such as SMS, MMS, Web, USSD etc. Specifically the illustrative SDK 16 includes: an integration component for payment processing; a component for integration with external supplier platforms to submit services products requests on behalf of the user and optionally to receive alerts (for example, bill payment alerts); a component for integration with a flexible security module that can be configure for full, partial or no personal identification number (PIN) verification.

The illustrative SDK 16 also provides coordination among the components to implement a purchasing transaction flow. For example the SDK 16 provides instructions for components to wait for a purchasing request from an application; to verify the user's credentials, requesting PIN verification if necessary; to open the user's wallet and request payment authorization; to communicate with the supplier platform to request the service/product for the user; and to settle the user's payment after acknowledgement. The SDK 16 also provides recovery of outstanding purchase requests on restart after an unexpected system shutdown.

Accordingly, the SDK 16 according to the illustrative embodiment of the present invention offers a simple application programming interface (API) to cash based purchase applications that hide much of the complexity typically involved in payment transactions. Applications developed with the SDK 16 can be end user applications using any channel (SMS, USSD, Hypertext Transfer Protocol (HTTP), Interactive Voice Response (IVR), etc.). The various components of the SDK 16 coordinate with the mobile payment platform and the service delivery platform according to the illustrative embodiments to maintain an extensive audit train of all transactions.

The following example demonstrates SMS based flow for a mobile top-up application according to an illustrative embodiment of the invention. It should be appreciated by persons skilled in the art that a different application could be substituted for the SMS channel or any other appropriate channel described within the scope of the present invention.

The mobile top-up SMS application is an end-user application that is built on top of the cash based purchasing SDK. The exemplary application interacts with users using SMS. It supports a flow for top-ups initiated by third party vendors on behalf of customers.

The exemplary application validates and interprets all messages for correctness. The content of all messages to and from the user is localized and brandable and the allowed top-up amounts are configurable. Top up requests are passed to the mobile top up SDK. When a Personal Identification Number (PIN) challenge is requested from the SDK, the application sends the appropriate SMS message to the end user. The application includes comprehensive error messages, including: bad message syntax; user not registered; user has insufficient funds; user did not reply within specific time; user requested an illegal top-up amount; and user provided an incorrect (or partial) PIN.

The following cash top-up application describes an SMS base flow. The cash top-up application according to the present invention allows third party vendors to perform top-ups on behalf of users from a stored value account belonging to the vendor. The vendor is a subscriber who has registered to become an authorized reseller of airtime, equipped with their mobile phone and a stored value module that is prepaid with funds.

The vendor's stored value modules can be updated against cash deposits or based on bank statements. The payment details are entered by the supplier's customer service personnel. All the transaction details are entered including description, credit amount for deposit, debit for withdrawal or adjustment and a reference number for audit trail.

Mobile vendors use a facility of the mobile top-up method according to the invention whereby they can top-up a third party's phone. In a particular example, a subscriber approaches the vendor with cash and requests a top-up for $50. The vendor provides the top-up using their mobile phone as the point of sale device, making payment for the transaction from their own stored value module in exchange for the cash.

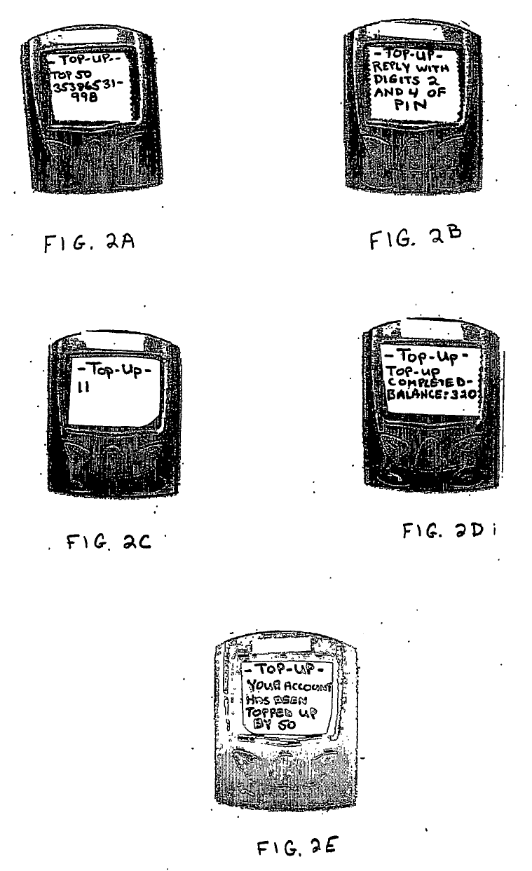

An implementation of the cash top-up method according to the present invention is described with reference to FIGS. 2A-2E. Using SMS the vendor types a predetermined syntax, which is configurable, wherein the vendor enters a command using syntax that includes the transaction type (e.g. TOP), the subscriber's phone number, and the amount. The vendor then submits the request (FIG. 2A). The mobile top-up system then sends the vendor a PIN challenge (FIG. 2B). The vendor replies with the PIN digits (FIG. 2C) and then receives confirmation of the top-up including the new stored value module balance of $320 (FIG. 2D). The subscriber also receives a top-up acknowledgement via SMS. (FIG. 2E).

Although the exemplary embodiments of the present invention have been described generally in terms of a mobile top-up application, persons skilled in the art should appreciate that any number of mobile commerce applications are suitable for use with the present invention. For example, the supplier using the present invention could be a utility company, such as an electric company. The present invention enables the sale of electricity top-up tokens via a network of distributors to customers who do not have a phone or bank account and who, for example, can only pay in cash. In this example, the distributor is registered with the utility company and has a distributor account in which a positive value (or credit) is maintained. A customer who wishes to purchase a token for her pre-paid electricity meter visits a distributor who is an agent for the utility company. The customer requests a token for her pre-paid meter by paying the distributor cash to the value of the token. The distributor sends a request to the mobile commerce system according to the present invention for a token to be generated for the customer. The mobile commerce system authenticates that the distributor is a legitimate distributor and that there is sufficient funds or credit in the distributors account to pay for the value of the token. The mobile commerce system according to the invention then transfers the value of the token from the distributor's account to the utility company's account. Upon completion of the payment transaction, the mobile commerce system accesses the utility company's token generation system and requests generation of a token for the value paid for by the customer. When the mobile commerce system of the present invention receives the token, from the utility's token generating system it sends the token to the distributor. The distributor receives the token and provides it to the customer. If a pre-paid meter is enabled for Global System for Mobile Communications (i.e., GSM enabled), the utility company may alternatively send the token directly to the customer's meter.

After the transaction, in each of the embodiments, the new balances are reflected in the stored value module management system and a balance notification is sent to the vendor as part of the transaction acknowledgement. Distributor side customer support personnel are equipped with a set of management screens designed to allow them to review the transactions performed by vendors.

To be eligible to provide such a service, a potential vendor applies and registers with a distributor. For example, the potential vendor can typically apply in person at a local network operator office, or some appointed agent of the distributor. The vendor's identification and security information is entered by the distributor's customer support personnel using a standard web interface, subject to appropriate presentation of proof of the vendor's identity.

A full registration according to an illustrative embodiment of the present invention includes the mobile subscriber integrated service digital network (MSISDN) of the vendor's telephone. An extensible data structure within the mobile wallet platform according to the invention can also collect custom registration data such as a digital photograph and the like. Following the registration of the vendor, a wallet and a stored value module account are created for the vendor and linked to their MSISDN. A secure PIN can then be generated and sent to the vendor's phone by SMS.

Vendor registration is supported through the mobile wallet customer service interface in the same way that the distributors support subscriber registrations for their regular customers. One significant difference is that vendors are provided with stored value module accounts that are intended for providing cash based top-up and other approved services to the public.

In one embodiment, distributors such as network operators may process cash deposits from vendors across the counter and credit the vendor's stored value module with the appropriate value of service, i.e., airtime. Persons skilled in the art should appreciate that a number of alternative methods can be used for crediting value to a vendor's stored value module within the scope of the present invention.

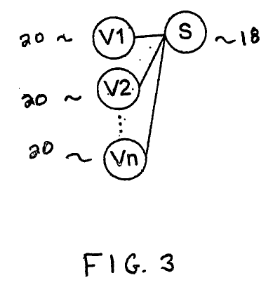

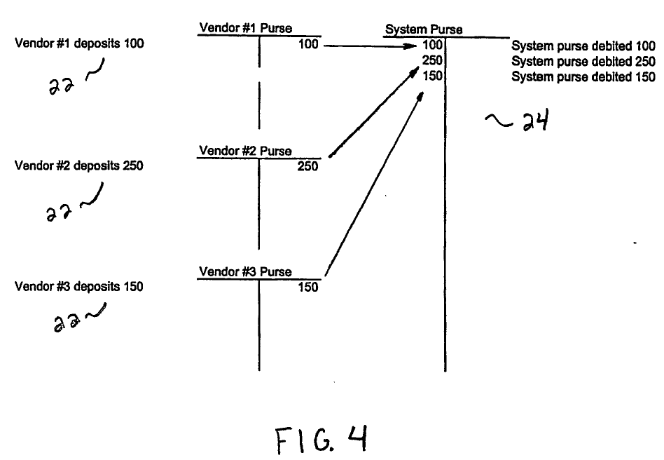

An illustrative method of crediting a vendor's stored value module (14, FIG. 1) having a “double entry mechanism” is described with reference to FIG. 3. According to the stored value module's double entry mechanism, the system stored value module (S) 18 is always in balance with vendor stored value modules (V1, V2 . . . Vn) 20. In an example shown in FIG. 4, when a vendor deposits cash, vendor stored value modules 22 are credited and system stored value module 24 is debited.

A simple web user interface is provided to the distributor's customer service personnel for manual entry of stored value module deposits. Deposits can be processed against cash receipts or from statements such as lodgement details, for example. In either case, a transaction reference (lodgement or receipt number) is recorded with each deposit and entered into the stored value module system to provide a complete audit trail. Automatic batch updates and on-line deposits are also possible via the underlying stored value module API, through integration.

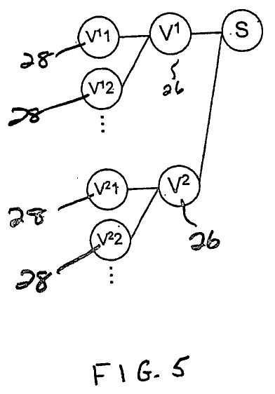

Another illustrative embodiment of the invention including a hierarchical stored value module structure is described with reference to FIG. 5. A hierarchical stored value module structure according to the illustrative embodiment, has the effect of minimizing the number of deposit transactions processed by a distributor's customer service personnel because the customer service personnel need only process a small number of large value deposits. A large portion of the funds transfer work is shifted to the vendors themselves. For example, in this embodiment, a group of high level vendors make a small number of large value payments to the distributor and in turn can distribute services to a group of affiliated sub-vendors. In the illustrative embodiment shown in FIG. 5, the larger vendors (V¹, V², . . . Vⁿ) 26 transfer funds to a hierarchy of sub-vendors (V¹1, V²2, . . . Vⁿn) 28, in exchange for cash deposits taken from the sub-vendors. In an illustrative embodiment, the hierarchical structure is configured to confine transfers between vendors and sub-vendors within defined channels.

In the hierarchical model, distributors can create or leverage existing distributor networks to distribute value between stored value modules. In this way, the operator receives a small number of large value deposits from appointed distributor or vendor channels, which greatly simplifies the task of managing and processing stored value module deposits.

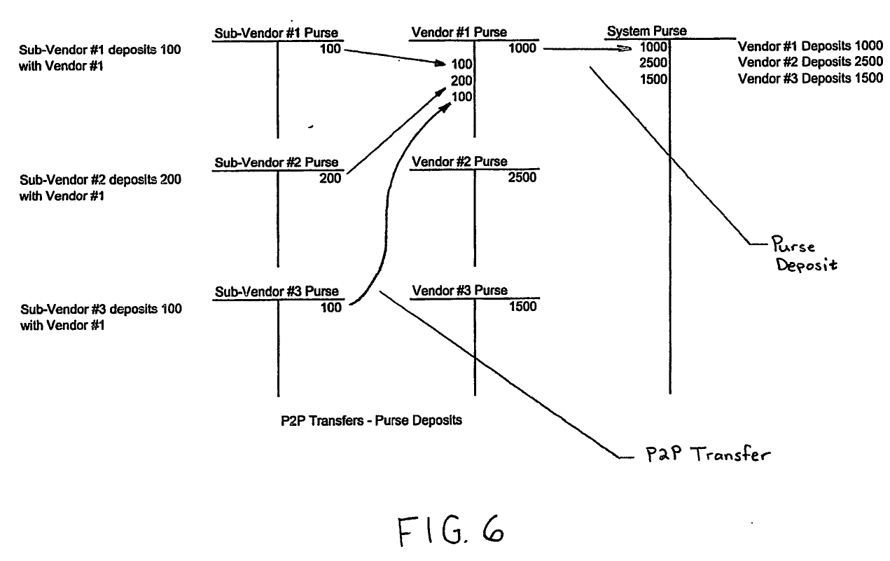

The basis of the hierarchical transfer of funds is the use of peer to peer (P2P) transfers which provide a mechanism whereby one stored value module account holder uses a mobile phone to transfer funds to another stored value module account holder, via SMS or USSD. As illustrated in an example shown in FIG. 6, the system according to the illustrative embodiment of FIG. 5 logs all transfers and transactions by vendors.

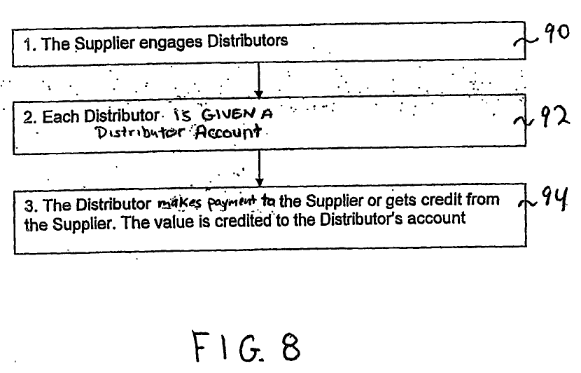

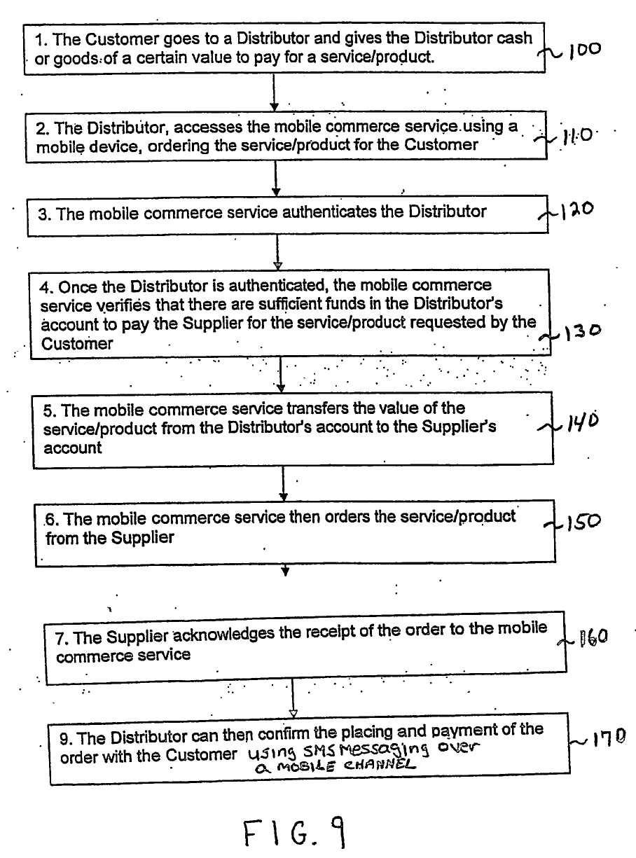

A general embodiment of the present invention is described herein with reference to FIGS. 8 and 9. The general embodiment provides a method for cash payment of goods ordered on-line in which a distributor's debit or credit account is established in a supplier's mobile commerce system.

As shown in FIG. 8, a supplier engages at least one distributor 90 in a contractual relationship, for example. Each distributor is given a distributor account 92. The distributor must then make payment with the supplier or receive credit with the supplier at which time value is credited to the distributors account 94. In a first step 100 of a customer transaction as shown in FIG. 9 payment is made from a customer to the distributor. In a next step 110 a request for the goods or services is communicated from the distributor to a supplier using a mobile device connecting to a mobile commerce system of the supplier. Next, authentication 120 of the distributor and verification 130 of the distributor's funds is performed by the mobile commerce system. The value of goods or services is transferred 140 from the distributor's account to the supplier's account in the supplier's mobile commerce system. The mobile commerce system then orders 150 the service/product from the supplier. An order acknowledgement is communicated 160 from the suppler to the distributor. Access to the goods or services is transferred from the distributor to the customer. The distributor can optionally inform the customer when a transaction has been completed. The distributor confirms 170 payment of the order with the customer using SMS messaging over a mobile channel.

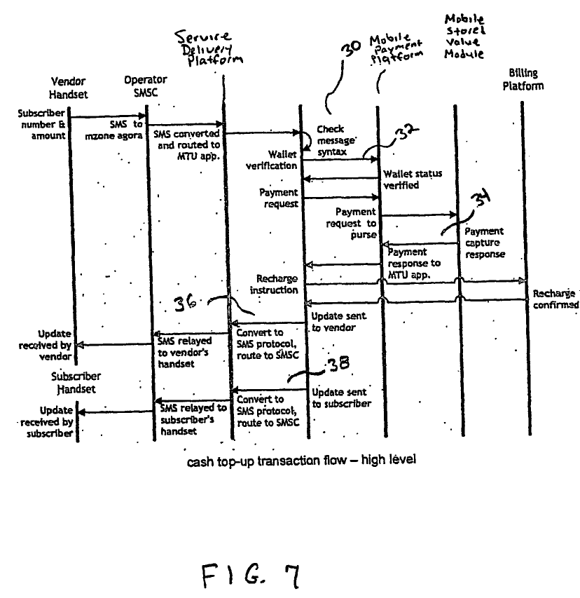

An example of a cash top-up transaction and payment processing method according to the platform in the embodiment of the invention of FIG. 1 is described with reference to FIG. 7. The mobile top-up application first processes transaction requests by checking message syntax 30 and implementing security and authentication rules 32 (i.e. requests/confirms a PIN). Next the application processes payment. The payment is received 34 from the vendor stored value module for cash top-ups. The customer presents cash value to the vendor. The application then processes top-ups. Finally, the application updates receipt and transaction logs. Full details of all transactions are recorded and an acknowledgment is sent to the top-up vendor 36 and the customer 38.

A vendor top up service according to an illustrative embodiment of the present invention may also provide for payment of commissions to vendors. There are at least two methods for handling commissions. In a pre-allocated commission structure, vendors are credited with value of airtime and pay a discounted amount of value (such as cash) to a distributor in advance. The total cost of sales to network operator is established in advance. This structure is self managing because it involves no commission calculation by the application.

Another illustrative commissions structure that can be employed according to the invention is a commission allocation after top-up sales. In this commission structure, the vendor earns commission after each transaction. Alternatively the vendor can earn a commission based on periodic calculation from transaction logs. This commission structure involves implementation of commission calculation logic and rules within the mobile top-up platform. Although particular commission structures are described herein, the system and method according to the present invention allows the implementation of any of various particular commission settlement models configured to individual operator requirements.

To minimize the possibility of sensitive data being intercepted or accessed by unauthorized third parties, the present invention provides security consistent with best practices known in the art. Accordingly, customers and vendors can make transactions using the systems and methods of the invention without providing any personal information over their mobile devices. Secure logs of all transactions are encrypted and stored while merchant access is authorized with digital certificates.

In an illustrative embodiment, security is handled at a number of levels within the system. These levels provide technology for secure transmission, technology for secure storage and access control and authentication. To secure transmission, transmission of data between the system of the invention and the various external access points is secured using industry standard encryption techniques. For web and mobile access, these techniques include Secure Sockets Layer Encryption (SSL), SGM encryption and Wireless Transport Layer Security Protocol (WTLS). To secure storage, all sensitive information stored by the system is encrypted using Triple Data Encryption Standard (DES), and additional encryption algorithms can be used on request.

Access control and authentication for mobile user is provided using PIN, partial PIN, derived PIN and/or confirmation of additional details (such as personal information) as defined by the operator/distributor. System administration and customer care users are authenticated based on user name and password. Access by external systems is restricted based on IP restrictions and digital certificates.

Although the system and method of the invention is described with respect to several illustrative embodiments thereof, it should be appreciated that the foregoing and various other changes, omissions, additions in the form and detail thereof could be implemented without changing the underlying invention or departing from the spirit and scope of the present invention.

What is claimed is:

1. A method for cash payment for goods or services in a mobile commerce system:
establishing a distributor's account; in a mobile commerce system wherein said mobile commerce system includes a supplier's account;
paying value for said goods or services from said customer to said distributor;
communicating a request for said goods or services from said distributor to a supplier using a communication device in said mobile commerce system;
authenticating said distributor by said mobile commerce system;
verifying said distributor's funds by said mobile commerce system;
transferring value for said goods or services from said distributor's account to said supplier's account;
and;
transferring access to said goods or services to said customer.

2. The method according to claim 1 further comprising communicating an order acknowledgement from said supplier to said distributor.

3. The method according to claim 1 further comprising communicating a transaction completed message from said distributor to said customer.

4. The method according to claim 1 wherein said access comprises a token provided to said customer which can be provided from said customer to said supplier to allow said customers direct access to said services.

5. The method according to claim 1 wherein said access comprises a code provided to said customer which can be provided from said customer to supplier to allow said customers direct access to said services.

6. The method according to claim 1 wherein said access comprises direct activation of said services by said supplier.

7. The method according to claim 1 wherein said communication device comprises a mobile communication device.

8. The method according to claim 1 wherein said communication device is a mobile phone.

9. The method according to claim 1 wherein said goods or services comprise airtime in a mobile telephone network.

10. The method according to claim 9 wherein said mobile telephone network includes said mobile commerce system.

11. The method according to claim 1 wherein said goods or services comprise a utility service.

12. The method according to claim 1 wherein service comprises delivery of electricity.

13. The method according to claim 1 wherein said distributor includes a network of sub-distributors and wherein value is transferred from said distributor's account to said supplier's account via said network of sub-distributors.

14. The method according to claim 13 wherein said network of sub-distributors is hierarchical.

15. The method according to claim 1 further comprising providing commission value to said distributor.

16. The method according to claim 15 wherein said commission value comprises a bulk discount for distributed services in relation to an amount deposited in said distributor's account.

17. The method according to claim 15 wherein said commission value comprises a payment calculated in relation to the value of sales made by said distributor.

18. A mobile commerce network comprising:
a mobile communication network;
a supplier having mobile communication capability over said mobile communication network;
a supplier's account addressable over said mobile communication network;
at least one distributor having mobile communication capability over said mobile communication network;
a distributor's account addressable over said mobile communication network;
wherein said supplier authenticates said distributor, verifies funds in said distributor's account, and transfers value to a customer in response to request received from said distributor over said mobile communication network.

19. The mobile commerce network according to claim 18 wherein said at least one distributor comprises a hierarchical network of distributors.

20. A cash based purchasing platform for creation of a mobile commerce network comprising:
a mobile payments platform including a mobile stored value module; and
a service delivery platform configured for integration with said mobile payments platform.

21. The cash based purchasing platform according to claim 20 wherein said mobile payments platform facilitates communication of electronic payment instructions between a distributor and supplier over said mobile commerce network; and
wherein said service delivery platform facilitates activation of services for a customer over said mobile commerce network.

22. The cash based purchasing platform according to claim 20 wherein said mobile stored value module facilitates established of a low cost network of distributors having deposit accounts for transfer of funds to a supplier in exchange for activation of services for a customer when a customer makes cash payments to a distributor.

23. The cash based purchasing platform according to claim 20 wherein said mobile payments platform and service delivery platform are capable of use with a plurality of different communication channel protocols.
